(19) United States
(12) Patent Application Publication
(10) Pub. No.: US 2026/0342471 A1
(43) Pub. Date: Oct. 29, 2026

(54) DYNAMIC MODULATION AND CODING SCHEME PER CODE BLOCK

(71) Applicant: QUALCOMM Incorporated, San Diego, CA (US)

(72) Inventors: Konstantin KUPERSHLAK, Ramat Gan (IL); Ran BERLINER, Kfar Aviv (IL); Shay LANDIS, Hod Hasharon (IL); Amit BAR-OR TILLINGER, Tel-Aviv (IL); Eitan YERUSHALMI, Tel-Aviv (IL); Ori SASON, Modiin (IL)

(21) Appl. No.: 19/187,855

(22) Filed: Apr. 23, 2025

(51) Int. Cl. H04L 1/00; H04L 5/00; H04W 72/231; H04W 76/20

(52) U.S. Cl. CPC H04L 1/0005; H04L 5/0044; H04W 72/231; H04W 76/20

(57) ABSTRACT

Certain aspects of the present disclosure provide techniques for wireless communications. An example method includes calculating a quantity of mapped code blocks based at least in part on a highest modulation and coding scheme (MCS) from a set of MCSs associated with the quantity of mapped code blocks; determining a set of code block sizes based at least in part on the quantity of mapped code blocks; selecting an MCS, from the set of MCSs, for a mapped code block in the quantity of mapped code blocks; identifying a code block size, from the set of code block sizes, for the mapped code block based at least in part on the MCS; calculating a transport block size based at least in part on the code block size selected for the mapped code block; and transmitting or receiving a communication in accordance with the transport block size.

### INTRODUCTION

### Field of the Disclosure

Aspects of the present disclosure relate to wireless communications, and more particularly, to techniques for applying dynamic modulation and coding scheme (MCS) per code block.

### DESCRIPTION OF RELATED ART

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

Certain aspects provide a method of wireless communications by a wireless communications device. The method includes calculating a quantity of mapped code blocks based at least in part on a highest modulation and coding scheme (MCS) from a set of MCSs associated with the quantity of mapped code blocks; determining a set of code block sizes based at least in part on the quantity of mapped code blocks, wherein each code block size in the set of code block sizes is determined further based at least in part on a unique MCS from the set of MCSs; selecting an MCS, from the set of MCSS, for a mapped code block in the quantity of mapped code blocks; identifying a code block size, from the set of code block sizes, for the mapped code block based at least in part on the MCS; calculating a transport block size based at least in part on the code block size selected for the mapped code block; and transmitting or receiving a communication in accordance with the transport block size.

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of network entities and a user equipment (UE).

FIGS. 4A, 4B, 4C, and 4D depict various example aspects of data structures for a wireless communications network.

FIG. 5depicts a process flow for communications in a network between a first wireless communications device and a second wireless communications device.

FIG. 6 depicts an example associated with dynamic modulation and coding scheme (MCS) per code block as described herein.

FIG. 7 depicts a method for wireless communications.

FIG. 8 depicts aspects of an example communications device.

### DETAILED DESCRIPTION

Aspects of the present disclosure provide apparatuses, methods, processing systems, and computer-readable mediums for applying dynamic modulation and coding scheme (MCS) per code block.

A modulation and coding scheme (MCS) is used to determine how a wireless communication is transmitted over a wireless channel. M ore particularly, an MCS defines a modulation type (e.g., quadrature phase shift keying (QPSK), 16 quadrature amplitude modulation (16QAM), 64QAM, or the like), which controls a quantity of bits represented in a given symbol, and a code rate, which determines a level of redundancy associated with providing error correction. Together, the modulation type and the coding rate impact the data rate and reliability of the wireless communication. In general, a higher MCS (e.g., an MCS with a higher modulation order and higher code rate) provides a higher throughput, but requires better signal quality. Conversely, a lower MCS (i.e., an MCS with a lower modulation and lower code rate) provides increased robustness (e.g., in poorer radio conditions). In practice, a network entity selects an MCS based on channel conditions to, for example, balance the data rate and reliability so as to optimize performance. Conventionally, the same MCS is applied for all code blocks in a transport block of a wireless communication.

Technical problems associated with the use of the same MCS for all code blocks of a transport block include, for example, reduced resource efficiency (e.g., reduced channel capacity efficiency) with respect to communication of one or more code blocks of the transport block. That is, applying the same MCS to all code blocks in a transport block can reduce resource efficiency. For example, a block error rate (BLER) associated with a communication is dictated by code blocks of the communication that are transmitted in resources with the worst channel conditions. This means that other code blocks of the communication that are transmitted in resources with comparatively better channel conditions may have a significant margin over the applied MCS. That is, the code blocks transmitted in resources with the comparatively better channel conditions are likely to be decoded at a receiver after a minimal quantity of decoding iterations, which implies low resource efficiency with respect to communication of those code blocks (e.g., that used channel capacity is significantly below an available channel capacity with respect to communication of the code blocks in the resources with better channel conditions).

An interleaver can be implemented in some scenarios so as to cause a given code block to be communicated in a set of pseudorandom resource blocks from an allocated set of resources. However, code blocks still experience different average channel conditions even when an interleaver is used. For example, while variation of mutual information (in bits) across code blocks is reduced as a result of the interleaver, some amount of channel condition imbalance remains, meaning that resource efficiency is sub-optimal.

Aspects described herein overcome the aforementioned technical problems, for example, by enabling dynamic MCS per code block of a transport block (i.e., allowing the MCS to vary among code blocks of a transport block rather than using the same MCS for all code blocks of the transport block). In some aspects, a wireless communications device may calculate a quantity of mapped code blocks based at least in part on a highest MCS from a set of MCSs. The wireless communications device may determine a set of code block sizes based at least in part on the quantity of mapped code blocks, with each code block size being determined based at least in part on a unique (different) MCS from the set of MCSs. The wireless communications device may then select an MCS for each mapped code block and identify code block size(s) for each mapped code block. The wireless communications device may then calculate a transport block size based at least in part on the code block sizes selected for each code block. The wireless communications device may then transmit (or receive) a communication in accordance with the transport block size. In this way, the MCS can be varied among code blocks of the transport block.

Certain techniques for applying dynamic MCS per code block described herein may provide various beneficial technical effects and/or advantages. The techniques for applying dynamic MCS per code block may enable improved wireless communications performance, such as increased resource efficiency and increased channel capacity efficiency. The improved wireless communication performance may be attributable to the techniques and apparatuses for applying dynamic MCS per code block described herein, for example, due to enabling the MCS to be varied among code blocks of a transport block, (e.g., such that code blocks that are transmitted in resources with the worst channel conditions do not dictate a BLER). Further, the techniques and apparatuses described herein may enable a legacy transport block calculation to be substantially reused with relatively minor changes, meaning that implementation of the dynamic MCS per code block in a wireless communications system is relatively straightforward. Additionally, the techniques and apparatuses described herein may enable a probability of error per code block to be substantially the same over a group of code blocks, which can allow for efficiency to be increased with respect to providing feedback for a given code block group (e.g., by enabling code block group feedback to be provided via a single bit).

### Introduction to Wireless Communications Networks

The techniques and methods described herein may be used for various wireless communications networks. While aspects may be described herein using terminology commonly associated with 3G, 4G, 5G, 6G, and/or other generations of wireless technologies, aspects of the present disclosure may likewise be applicable to other communications systems and standards not explicitly mentioned herein.

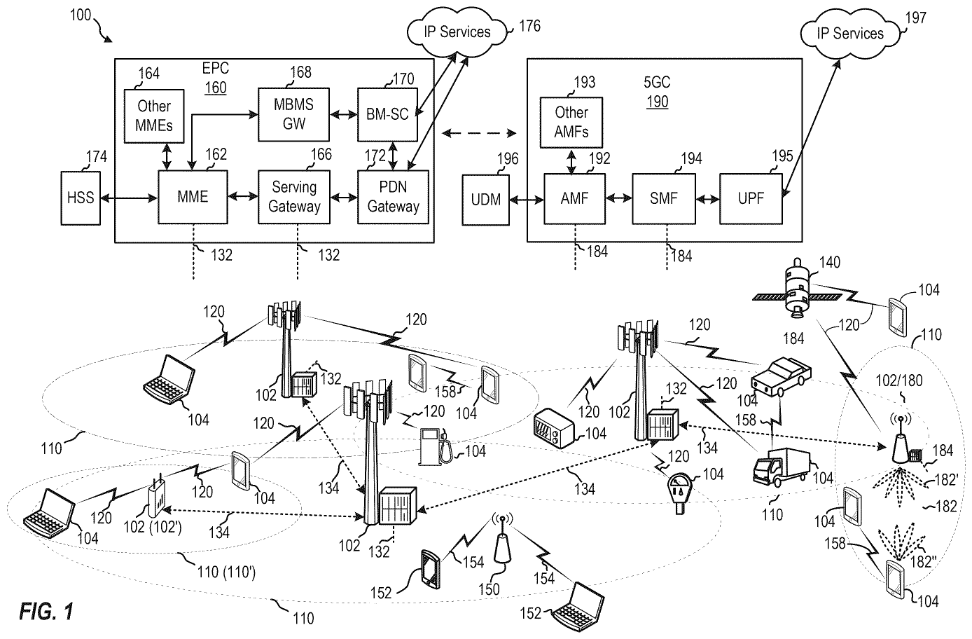

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). As such communications devices are part of wireless communications network 100, and facilitate wireless communications, such communications devices may be referred to as wireless communications devices. For example, various functions of a network as well as various devices associated with and interacting with a network may be considered network entities. Further, wireless communications network 100 may include terrestrial aspects, such as ground-based network entities (e.g., BSs 102), and non-terrestrial aspects (also referred to herein as non-terrestrial network entities). A non-terrestrial network entity may include satellite 140, which may be an example of an aerial or space-borne platform. In some examples, satellite 140 may include one or more network entities on-board (e.g., one or more BSs) capable of communicating with other network elements (e.g., terrestrial BSs) and UEs. For example, satellite 140 may be implemented according to a regenerative architecture (also referred to as a non-transparent architecture), and a gNB implemented at satellite 140 may implement higher-layer network functions. As another example, satellite 140 may be implemented according to a transparent architecture, and may perform a physical or other lower-layer repeater function for UEs and a network entity (such as a gateway associated with the satellite 140).

In the depicted example, wireless communications network 100 includes BSs 102, UEs 104, and one or more core networks, such as an Evolved Packet Core (EPC) 160 or a 5G Core (5GC) network 190, which interoperate to provide communications services over various communications links, including wired and wireless links. In some aspects, a core network, such as a 6G core, may implement a converged service-based architecture. In a converged service-based architecture, functions traditionally split between a core network (such as κGC network 190) and a radio access network (RAN) (such as BS 102) may be implemented at a single network entity. For example, a mobility network entity may perform both core network functions and RAN functions related to mobility of UEs 104 attached to the wireless communications network 100. “Network entity” can refer to a BS 102, a network entity of EPC 160 or 5GC network 190, or a network entity of a converged service-based architecture.

FIG. 1 depicts various example UEs 104. UE 104 may include a cellular phone, a smart phone, a session initiation protocol (SIP) phone, a laptop, a personal digital assistant (PDA), a satellite radio, a Global Positioning System device, a multimedia device, a video device, a digital audio player, a camera, a game console, a tablet, a smart device, a wearable device, a vehicle, an electric meter, a gas pump, a kitchen appliance, a healthcare device, an implant, a sensor/actuator, a display, an Internet of Things (IoT) device, an always on (AON) device, an edge processing device, a data center, or another similar device. A UE 104 may also be referred to as a mobile device, a wireless device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. A communications link 120 between a BS 102 and a UE 104 may include uplink (UL) (also referred to as reverse link) transmissions from a UE 104 to a BS 102 and/or downlink (DL) (also referred to as forward link) transmissions from a BS 102 to a UE 104. A communications link 120 may use multiple-input and multiple-output (MIMO) antenna technology, including spatial multiplexing, beamforming, and/or transmit diversity in various aspects.

A BS 102 may include a NodeB, an enhanced NodeB (eNB), a next generation enhanced NodeB (ng-eNB), a next generation NodeB (gNB or gNodeB), an access point, a base transceiver station, a radio base station, a radio transceiver, a transceiver function, a transmission reception point (TRP), a radio unit (RU), a distributed unit (DU), or the like. A given BS 102 may provide communications coverage for a coverage area 110, which may sometimes be referred to as a cell, and which may overlap another coverage area 110 (e.g., a small cell provided by a BS 102′) may have a coverage area 110′ that overlaps the coverage area 110 of a macro cell). A BS 102 may, for example, provide communications coverage for a macro cell (covering a relatively large geographic area), a pico cell (covering a relatively smaller geographic area, such as a sports stadium), a femto cell (covering a relatively smaller geographic area, such as a home), or another type of cell.

The term “cell” may refer to a portion, partition, or segment of wireless communication coverage served by a network entity within a wireless communications network 100. A cell may have geographic characteristics, such as a geographic coverage area, as well as radio frequency characteristics, such as time and/or frequency resources dedicated to the cell. For example, a specific geographic coverage area may be covered by multiple cells employing different frequency resources (e.g., bandwidth parts) and/or different time resources. As another example, a specific geographic coverage area may be covered by a single cell. In some contexts (e.g., a carrier aggregation scenario and/or multi-connectivity scenario), the terms “cell” or “serving cell” may refer to or correspond to a specific carrier frequency (e.g., a component carrier) used for wireless communications, and a “cell group” may refer to or correspond to multiple carriers used for wireless communications. As examples, in a carrier aggregation scenario, a UE may communicate on multiple component carriers corresponding to multiple (serving) cells in the same cell group, and in a multi-connectivity (e.g., dual connectivity) scenario, a UE may communicate on multiple component carriers corresponding to multiple cell groups.

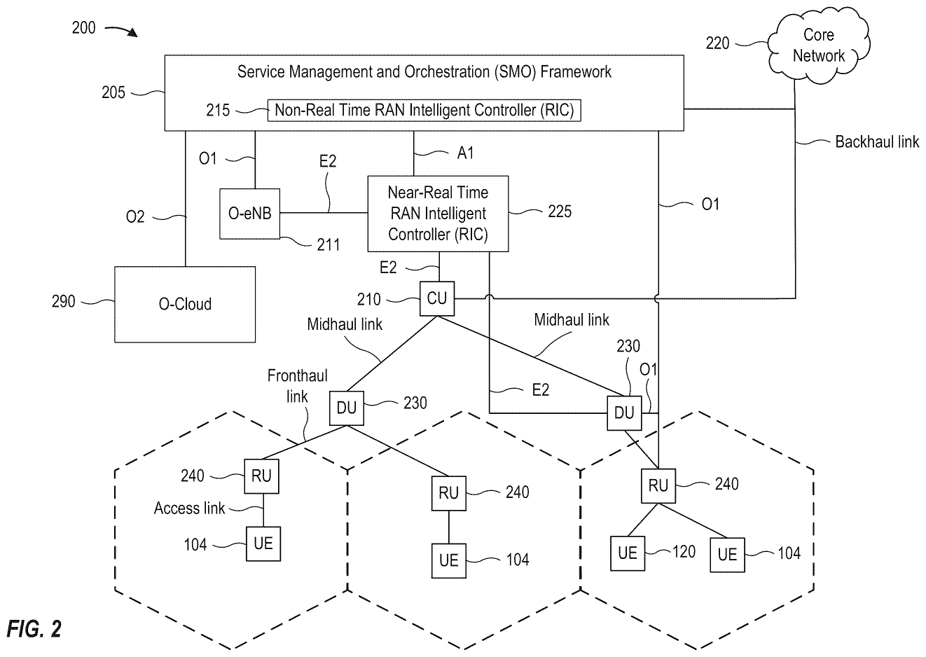

While BSs 102 are depicted in various aspects as unitary communications devices, BSs 102 may be implemented in various configurations. For example, one or more components of a base station may be disaggregated, including a central unit (CU), one or more DUs, one or more RUs, a Near-Real Time (Near-RT) RAN Intelligent Controller (RIC), or a Non-Real Time (Non-RT) RIC, to name a few examples. In another example, various aspects of a base station may be virtualized. A base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. Implementing a base station in this fashion may provide efficiency gains by enabling cloud-based implementation of certain (e.g., non-time-sensitive) higher-layer functions while physical-layer or other lower-layer functions can be implemented at or in proximity to a geographic coverage area of a corresponding cell. In some aspects, a base station including components that are located at various physical locations may be referred to as having a disaggregated RA N architecture, such as an Open RAN (O-RAN) or Virtualized RAN (VRAN) architecture. FIG. 2depicts and describes an example disaggregated RAN architecture.

Different BSs 102 within wireless communications network 100 may also be configured to support different radio access technologies, such as 3G, 4G, 5G, and/or 6G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or the 5GC 190) with each other over third backhaul links 134 (e.g., an X2 or XN interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, the Third Generation Partnership Project (3GPP) currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-71,000 MHz, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mmWave/near mmWave radio frequency bands (e.g., a mmWave base station such as BS 180) may utilize beamforming (e.g., 182) with a UE (e.g., 104) to improve path loss and range.

A communications links 120 may be through one or more carriers, which may have different bandwidths (e.g., 5 MHz, 10 MHz, 15 MHz, 20 MHz, 100 MHz, 400 MHz, and/or other bandwidths), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., base station 180 in FIG. 1) may utilize beamforming (indicated by reference number 182) with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may perform beam training to determine suitable receive and transmit directions for each of BS 180 and UE 104. Notably, the transmit and receive directions for BS 180 may or may not be the same. Similarly, the transmit and receive directions for UE 104 may or may not be the same.

Wireless communications network 100 may include a Wi-Fi access point (AP) 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. In some examples, D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH). D2D communications link 158 may be implemented using a variety of technologies, such as a radio access technology (e.g., 5G, ProSe sidelink), a WiFi technology, a Bluetooth technology, or the like.

EPC 160 may include various functional components, such as a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172. MME 162 may be in communication with a Home Subscriber Server (HSS) 174. MME 162 is a control node that processes signaling between the UEs 104 and the EPC 160. Generally, MME 162 provides bearer and connection management.

Generally, user Internet protocol (IP) packets are transferred through Serving Gateway 166. Serving gateway 166 is connected to PDN Gateway 172. PDN Gateway 172 provides UE IP address allocation as well as other functions. PDN Gateway 172 and BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBM S Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, such as an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and the 5GC 190. AMF 192 provides, for example, quality of service (QoS) flow and session management.

IP packets are transferred through UPF 195, which is connected to the IP Services 197. UPF 195 may provide UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a core network entity, or a sidelink node, to name a few examples.

FIG. 2 depicts an example disaggregated base station 200 architecture. The disaggregated base station 200 architecture may include one or more CUs 210 that can communicate directly with a core network 220 or other CUs 210 via a backhaul link (such as backhaul link 134), or indirectly with the core network 220 through one or more disaggregated base station units (such as a Near-Real Time (Near-RT) RAN Intelligent Controller (RIC) 225 via an E2 link, a Non-Real Time (Non-RT) RIC 215 associated with a Service Management and Orchestration (SMO) Framework 205, or both). A CU 210 may communicate with one or more DUs 230 via respective midhaul links, such as an F1 interface. The DUs 230 may communicate with one or more RUs 240 via respective fronthaul links. The RUs 240 may communicate with respective UEs 104 via one or more radio frequency (RF) access links (such as communications link 120). In some implementations, a UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or a processor or controller providing instructions to the interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter, or a transceiver (such as a RF transceiver), configured to receive or transmit signals, or both, over a wireless transmission medium.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230 for network control and signaling.

The DU 230 may be or correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUS 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more DUs 230 and/or one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

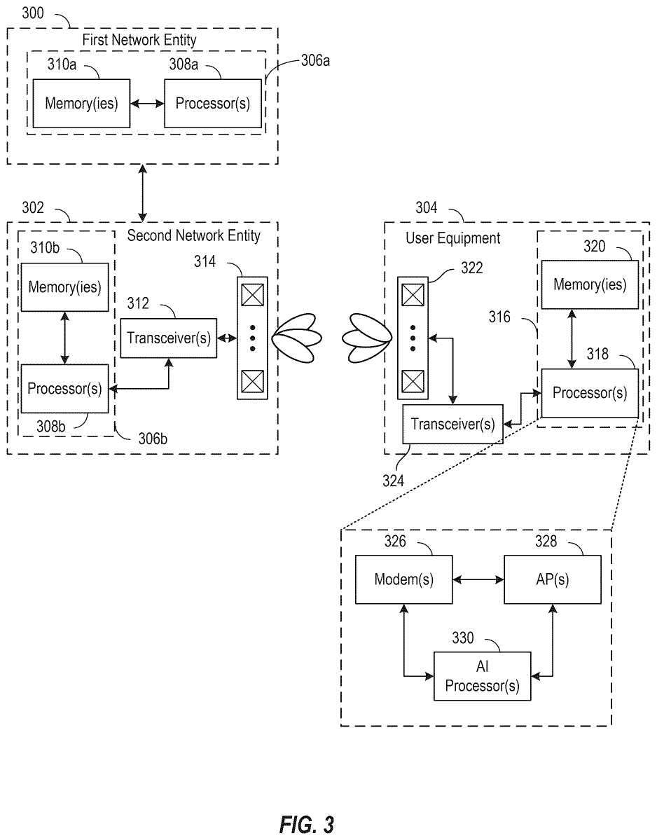

FIG. 3 depicts aspects of network entities 300 and 302 and a UE 304.

FIG. 3 includes a first network entity 300 and a second network entity 302. In some examples, first network entity 300 may be an example of a CU 210 or a DU 230. In some examples, second network entity 302 may be an example of a DU 230 or an RU 240. First network entity 300 and second network entity 302 may communicate with one another via a communications link, such as a midhaul link. In some examples, first network entity 300 and second network entity 302 may be implemented at a same BS (e.g., BS 102). For example, first network entity 300 and second network entity 302 may be co-located. In some other examples, first network entity 300 may be implemented separately from second network entity 302. For example, first network entity 300 may be implemented as a function (e.g., one or more processes) running on a server, such as in a cloud (e.g., a public or private cloud). As another example, first network entity 300 may be implemented as a virtual computing instance (e.g., virtual machine, container, etc.) or as a physical server.

First network entity 300 and second network entity 302 each include a processing system 306, illustrated as “processing system 306a” at first network entity 300 and “processing system 306b” at second network entity 302. For example, first network entity 300 and second network entity 302 may include one or more chips, system-on-chips (SoCs), system-in-packages (SiPs), chipsets, packages, or devices that individually or collectively constitute or comprise a processing system 306. A processing system 306 includes one or more processors 308 (illustrated as “processor(s) 308a” and “processor(s) 308b”) and one or more memories 310 (illustrated as “memory(ies) 310a” and “memory(ies) 310b”) coupled to the one or more processors 308. The one or more processors 308 may include one or multiple processors, microprocessors, processing units (such as central processing units (CPUs), graphics processing units (GPUs), neural processing units (NPUs) (also referred to as neural network processors or deep learning processors (DLPs)) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

In some aspects, the processing system 306 may perform processing (such as digital signal processing) of data, control information, or signals received or transmitted by a network entity. For example, the processing system 306 may include a coder, a decoder, a multiplexer, a demultiplexer, a transmit MIMO processor, a transmit processor, a receive processor, a receive MIMO detector, an automatic gain control component, or the like.

The one or more memories 310 may include one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). The one or more memories 310 may store data and program code for first network entity 300 and/or second network entity 302.

As further shown, second network entity 302 includes one or more transceivers 312 (illustrated as “transceiver(s) 312”). The one or more transceivers 312 may perform processing related to implementing physical layer (e.g., radio, air interface) communication with other devices such as UE 304. The one or more transceivers 312 may include one or more radio frequency (RF) components, such as an RF transceiver, a front-end module (e.g., an RF front-end (RFFE)), or the like. For example, the one or more transceivers 312 may include a transmit path (also referred to as a transmit chain), a receive path (also referred to as a receive chain), and/or an interface with one or more antennas 314.

The one or more antennas 314 may perform wireless transmission and reception of signals. The one or more antennas 314 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

UE 304 may be an example of UE 104. As shown, UE 304 includes a processing system 316. For example, UE 304 may include one or more chips, SoCs, SiPs, chipsets, packages, or devices that individually or collectively constitute or comprise a processing system 316. A processing system 316 includes one or more processors 318, and one or more memories 320 coupled to the one or more processors 318. Further, UE 304 includes one or more antennas 322, one or more transceivers 324, and/or other components that enable wireless transmission and reception of data.

The one or more processors 318 may include one or multiple processors, microprocessors, processing units (such as CPUs, GPUs, NPUs (also referred to as neural network processors or DLPs) and/or DSPs), processing blocks, ASICs, PLDs (such as FPGA s), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. In some aspects, the processing system 316 may perform processing (such as digital signal processing) of data, control information, or signals received or transmitted by a network entity. For example, the processing system 316 may include a coder, a decoder, a multiplexer, a demultiplexer, a transmit MIMO processor, a transmit processor, a receive processor, a receive MIMO detector, an automatic gain control component, or the like.

As shown, in some examples, the one or more processors 318 may include one or more modems 326, one or more application processors (APs) 328, one or more AI processors 330, a combination thereof, and/or another form of processor.

The one or more modems 326 may include a digital signal processor that converts information into a waveform for analog signal transmission (e.g., via modulation) and/or converts the waveform of a received signal into information (e.g., via demodulation). The one or more modems 326 may process information or waveforms in connection with signal transmission or reception. For example, the one or more modems 326 may include a coder, a decoder, a multiplexer, a demultiplexer, a transmit MIMO processor, a transmit processor, a receive processor, a receive MIMO detector, an automatic gain control component, or the like.

The one or more APs 328 may perform processing relating to an operating system and/or a higher layer application of the UE 304. For example, the one or more APs 328 may provide a higher-level operating system (HLOS), software, audio or video processing, graphics processing, or the like. In some examples, the one or more APs 328 may be a data source (e.g., for transmissions) or a data sink (e.g., for receptions).

The one or more transceivers 324 may perform processing related to implementing physical layer (e.g., radio, air interface) communication with other devices such as other UEs 304 or second network entity 302. The one or more transceivers 324 may include one or more RF components, such as an RF transceiver, a front-end module (e.g., an RFFE), or the like. For example, the one or more transceivers 324 may include a transmit path (also referred to as a transmit chain), a receive path (also referred to as a receive chain), and/or an interface with one or more antennas 322.

The one or more antennas 322 may perform wireless transmission and reception of signals. The one or more antennas 322 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3

For an example downlink transmission by second network entity 302, the processing system 306 (e.g., a transmit processor) may receive data and/or control information. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and/or others. The data may be for the physical downlink shared channel (PDSCH), in some examples.

The processing system 306 (e.g., a transmit processor) may process (e.g., encode and symbol map) the data and control information to obtain data symbols and control symbols, respectively. The processing system 306 may also generate reference symbols, such as for the primary synchronization signal (PSS), secondary synchronization signal (SSS), PBCH demodulation reference signal (DMRS), or channel state information reference signal (CSI-RS).

The processing system 306 (e.g., a TX MIMO processor) may perform spatial processing (e.g., precoding) on the data symbols, the control symbols, and/or the reference symbols, if applicable, and may provide output symbol streams to one or more modulators of the processing system 306. The one or more modulators may process one or more respective output symbol streams to obtain an output sample stream. The one or more transceivers 312 may process (e.g., convert to analog, amplify, filter, and upconvert) the output sample stream to obtain a downlink signal. Second network entity 302 may transmit the downlink signal via the one or more antennas 314.

In order to receive the downlink transmission at UE 304 (or a sidelink transmission from another UE), the one or more antennas 322 may receive the downlink signal and may provide received signals to the one or more transceivers 324. The one or more transceivers 324 may condition (e.g., filter, amplify, downconvert, and digitize) the received signals to obtain input samples. The one or more transceivers 324 and/or the processing system 316 may further process the input samples to obtain received symbols.

The processing system 316 (e.g., modem 326, an RX MIMO detector) may obtain the received symbols, perform MIMO detection on the received symbols if applicable, and provide detected symbols. The processing system 316 (e.g., a modem 326, a receive processor) may process (e.g., de-interleave and decode) the detected symbols. The processing system 316 may provide decoded data for the UE 304 (e.g., to an AP 328) and/or decoded control information (e.g., to a controller/processor of the processing system 316).

For an example uplink transmission or a sidelink transmission from UE 304, the processing system 316 (e.g., modem 326, a transmit processor) may receive and process data and/or control information to obtain a set of symbols for transmission. The data may be for the physical uplink shared channel (PUSCH), and may be received from a data source such as the AP 328. The control information may be for the physical uplink control channel (PUCCH), and may be received, for example, from a controller/processor of the processing system 316. The processing system 316 (e.g., a modem 326, the transmit processor) may also generate reference symbols for a reference signal (e.g., for a sounding reference signal (SRS), a demodulation reference signal, a phase tracking reference signal, or the like). In some examples, the symbols and/or reference signals may be precoded by the processing system 316 (e.g., modem 326, a TX MIMO processor), further processed by the one or more transceivers 324 (e.g., for SC-FDM), and transmitted to second network entity 302.

At second network entity 302, the uplink signals from UE 304 may be received by the one or more antennas 314, conditioned by the one or more transceivers 312 (e.g., filtered, amplified, downconverted, and digitized), detected (e.g., by the processing system 306b such as a modem and/or an RX MIMO detector), and further processed by the processing system 306b (e.g., a modem and/or a receive processor) to obtain decoded data and control information sent by UE 304. The processing system 306b may provide the decoded data and the decoded control information (such as to a controller/processor of the processing system 306b, an AP, first network entity 300, or another entity).

In various aspects, a wireless communication device, such as first network entity 300, second network entity 302, BS 102, UE 104, or UE 304 may be described as sending, transmitting, obtaining, or receiving various types of data associated with the methods described herein. In these contexts, “transmitting” or “sending” may refer to various mechanisms of outputting data, such as outputting data from a processing system, one or more memories, one or more transceivers, one or more antennas, and/or other aspects described herein. For example, “sending” or “transmitting” by a device may include sending (such as wirelessly, via a wired connection, or both) to a recipient directly or via another device. As another example, “sending” or “transmitting” may include sending internally to a device (such as the UE 304, first network entity 300, or second network entity 302) by a process to memory. “Receiving” or “obtaining” may refer to various mechanisms of obtaining data, such as obtaining data from the processing system, one or more memories, one or more transceivers, one or more antennas, and/or other aspects described herein. For example, “receiving” or “obtaining” by a device may include obtaining (such as wirelessly, via a wired connection, or both) from a recipient directly or via another device. As another example, “receiving” or “obtaining” may include obtaining internally to a device (such as the UE 304, first network entity 300, or second network entity 302) by a process from memory. As used herein, “communicating” by a device may include sending, obtaining, receiving, and/or transmitting a communication. “Communicating” can refer to communication with another device or internal communication of the device.

In various aspects, the processing system 306 or the processing system 316 may include one or more AI processors (such as AI processor 330 of the processing system 316). An AI processor may perform AI processing. The AI processor may include AI accelerator hardware or circuitry such as one or more neural processing units (NPUs), one or more neural network processors, one or more tensor processors, one or more deep learning processors, etc. As an example, the AI processor may perform AI-based beam management, AI-based channel state feedback (CSF), AI-based antenna tuning, and/or AI-based positioning (e.g., non-line of sight positioning prediction). In some cases, at the UE 104, the AI processor may process feedback generated by the UE 304 (e.g., CSF) using hardware accelerated AI inferences and/or AI training. In some cases, at the second network entity 302, the AI processor may decode compressed CSF from the UE 304, for example, using a hardware accelerated AI inference associated with the CSF. In certain cases, the AI processor may perform certain RAN-based functions including, for example, network planning, network performance management, energy-efficient network operations, etc.

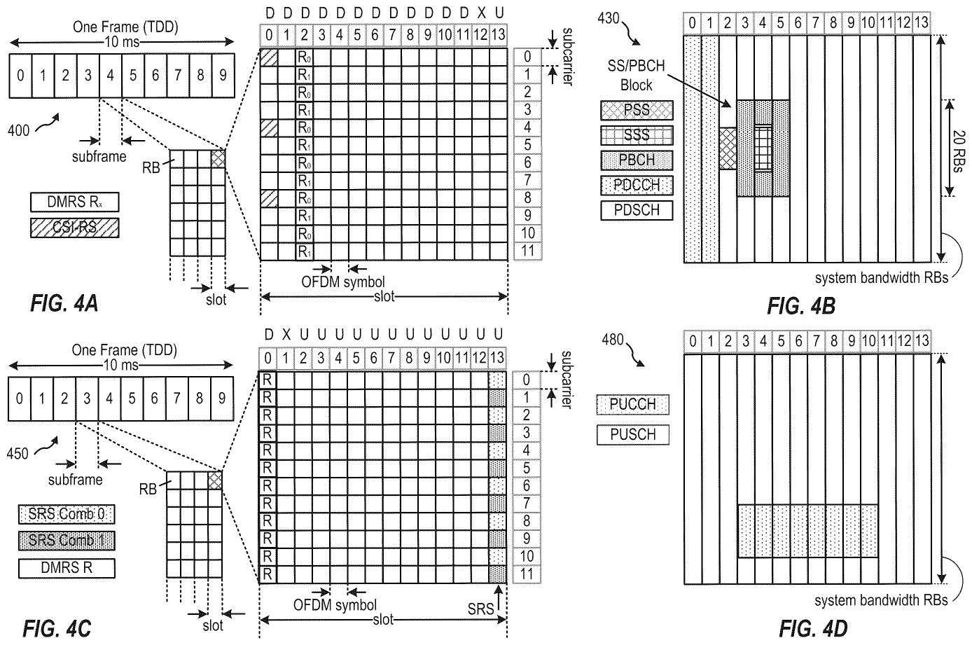

FIGS. 4A, 4B, 4C, and 4D depict aspects of data structures for a wireless communications network, such as wireless communications network 100 of FIG. 1

FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. One or more subcarriers may be modulated with data. Modulation symbols may be sent in the frequency domain with OFDM and/or in the time domain with SC-FDM.

In some examples, a wireless communications frame structure may be implemented using frequency division duplexing (FDD). In FDD, some subcarriers may be configured for DL communication, and other subcarriers (which may overlap in time with the DL subcarriers) may be configured for UL communication. In some other examples, wireless communications frame structures may be implemented using time division duplexing (TDD). In TDD, for a particular set of subcarriers, some subframes are configured for DL communication and other subframes are configured for UL communication.

In FIGS. 4A and 4C, the wireless communications frame structure is implemented using TDD. “D” indicates DL time resources, “U” indicates UL time resources, and “X” indicates flexible time resources for use or later reconfiguration for either DL or UL communication. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 12 or 14 symbols, depending on the cyclic prefix (CP) type (e.g., 12 symbols per slot for an extended CP or 14 symbols per slot for a normal CP). Subframes may also include mini-slots, which generally have fewer symbols than an entire slot. Other wireless communications technologies may have a different frame structure and/or different channels.

In certain aspects, the number of slots within a subframe (e.g., a slot duration in a subframe) is based on a numerology. A numerology may define a frequency domain subcarrier spacing and symbol duration, and may be configured for a given bandwidth part, carrier, cell, or network entity. In certain aspects, given a numerology u, there are 24 slots per subframe. Thus, numerologies (μ) 0 to 6 may allow for 1, 2, 4, 8, 16, 32, and 64 slots, respectively, per subframe. In some cases, an extended CP (e.g., 12 symbols per slot) may be used with a specific numerology, such as numerology μ=2 allowing for 4 slots per subframe. The subcarrier spacing and symbol length/duration are a function of the numerology. The subcarrier spacing may be equal to 2^{μ}×15 kHz. As an example, the numerology μ=0 corresponds to a subcarrier spacing of 15 kHz, and the numerology μ=6 corresponds to a subcarrier spacing of 960 kHz. The symbol length/duration is inversely related to the subcarrier spacing. FIGS. 4A, 4B, 4C, and 4D provide an example of a slot format having 14 symbols per slot (e.g., a normal CP) and a numerology μ=2 with 4 slots per subframe. In such a case, the slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as a physical RB (PRB)) that extends across, for example, 12 consecutive subcarriers. The resource grid is divided into multiple resource elements (REs). An RE may include a single subcarrier in the frequency domain and a single symbol in the time domain. The number of bits carried by each RE depends on the modulation scheme including, for example, quadrature phase shift keying (QPSK) or quadrature amplitude modulation (QAM).

As illustrated in FIG. 4A, some of the REs carry reference (pilot) signals (shown as “RS”) for a UE (e.g., UE 104 of FIGS. 1 and 3). The RS may include a demodulation RS (DM RS) and/or a channel state information reference signals (CSI-RS) for channel estimation at the UE. The RS may additionally or alternatively include a beam measurement RS (BRS), a beam refinement RS (BRRS), and/or a phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block (SSB), and in some cases, referred to as a synchronization signal block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as “R” for one particular configuration, but other DM RS configurations are possible) for channel estimation at the base station. The UE may transmit DM RS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

Example Signaling Associated with Dynamic MCS Per Code Block

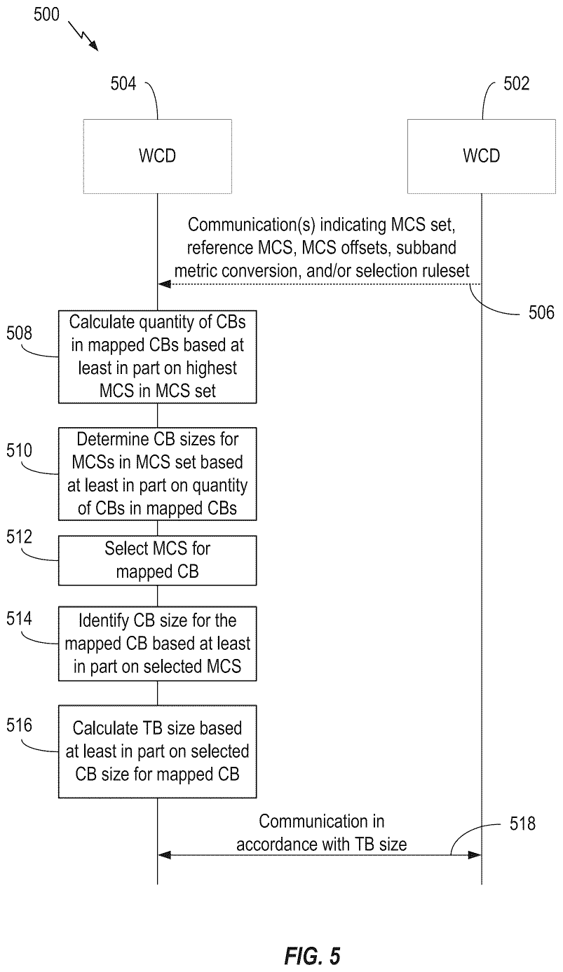

FIG. 5 depicts a process flow 500 for communications in a network between a wireless communications device 502 and a wireless communications device 504. In some aspects, the wireless communications device 502 may be an example of the BS 102 depicted and described with respect to FIG. 1 the first network entity 300 or the second network entity 302 depicted and described with respect to FIG. 3, a disaggregated base station depicted and described with respect to FIG. 2 the UE 104 depicted and described with respect to FIG. 1, or the UE 304 depicted and described with respect to FIG. 3. The wireless communications device 504 may be an example of the BS 102 depicted and described with respect to FIG. 1 the first network entity 300 or the second network entity 302 depicted and described with respect to FIG. 3, a disaggregated base station depicted and described with respect to FIG. 2 the UE 104 depicted and described with respect to FIG. 1, or the UE 304 depicted and described with respect to FIG. 3. However, in other aspects, wireless communications device 502 may be another type of wireless communications device and wireless communications device 504 may be another type of network entity or network node, such as those described herein. Note that any operations or signaling illustrated with dashed lines may indicate that that operation or signaling is an optional or alternative example.

At 506, the wireless communications device 504 receives, from the wireless communications device 502, one or more communications including information associated with applying dynamic MCS per code block with respect to transmitting or receiving a communication.

For example, the wireless communications device 504 may in some aspects receive a configuration indicating a set of MCSs. The set of MCSs may comprise a set of MCSs from which the wireless communications device 504 may select MCSs for mapped code blocks of a communication, as described herein. In some aspects, the set of MCSS may comprise, for example, a plurality of MCS indices, each of which corresponds to an entry in an MCS table configured on the wireless communications device 504. Each entry in the MCS table may indicate, for example, a modulation order, a code rate, a spectral efficiency (e.g., a value representing a product of the modulation order and the code rate), or the like. In some aspects, the set of MCSs includes a quantity of i MCSs such that a given MCS in the set of MCSs can be noted as MCSᵢ, where i={0 . . . N_{MCS}−1} and N_{MCS} represents the quantity of MCSs in the set of MCSs. In some aspects, the set of MCSs may be referred to as a spectral efficiency set.

As another example, the wireless communications device 504 may receive an indication of a reference MCS. The reference MCS is an MCS based on which an MCS for a given mapped code block can be selected. For example, in some aspects, the MCS for the given mapped code block may be selected based on a difference between the reference MCS and an MCS offset associated with the mapped code block, as described below with respect to operation 512. In some aspects, the wireless communications device 504 may receive the indication of the reference MCS in downlink signaling, such as in downlink control information (DCI).

As another example, the wireless communications device 504 may receive a configuration indicating a set of MCS offsets. An MCS offset is a parameter indicating an offset relative to the reference MCS. In some aspects, each MCS offset in the set of MCS offsets is associated with a different subband in a plurality of subbands. In some aspects, an MCS for a given mapped code block may be selected based on a difference between the reference MCS and an MCS offset from the set of MCS offsets, as described below with respect to operation 512. In some aspects, the wireless communications device 504 may receive the configuration indicating the set of MCS in, for example, a medium access control (MAC) control element (CE). Thus, the wireless communications device 504 may in some aspects determine the set of MCS offsets based on the set of MCS offsets being explicitly indicated to the wireless communications device 504 (e.g., in a MAC CE). As another example, the wireless communications device 504 may receive a configuration associated with converting reported subband metrics to MCS offsets. That is, the wireless communications device 504 may in some aspects be provided with a configuration for converting reported subband metrics (e.g., metrics, associated with one or more subbands, that are reported by the wireless communications device 504) to MCS offsets. In some such aspects, the wireless communications device 504 may convert a set of reported subband metrics to a set of MCS offsets in accordance with the configuration. Thus, the wireless communications device 504 may in some aspects convert a set of reported subband metrics to determine the set of MCS offsets (e.g., rather than the set of MCS offsets being explicitly signaled to the wireless communications device 504). In some aspects, the configuration associated with converting the reported subband metrics to MCS offsets may be received in a radio resource control (RRC) configuration.

As another example, the wireless communications device 504 may receive a configuration indicating a set of rules for selecting MCS offsets when a plurality of subbands at least partially overlap a given mapped code bock. In some aspects, the configuration indicating the set of rules may be received via, for example, RRC signaling. Alternatively, the wireless communications device 504 may be configured with the set of rules in accordance with a wireless communications standard (e.g., the set of rules may be defined by an applicable wireless communications standard rather than being configured by the wireless communications device 502).

In the example process flow 500, the wireless communications device 504 is to communicate (e.g., transmit or receive) a communication. In association with communicating the communication, the wireless communications device 504 is to calculate a transport block size (e.g., to determine how much data is to be communicated in a set of resources allocated for the communication). The following operations describe the process for calculation of a transport block size so as to provide of dynamic MCS per code block (e.g., such that the MCS may vary among code blocks of a transport block of the communication).

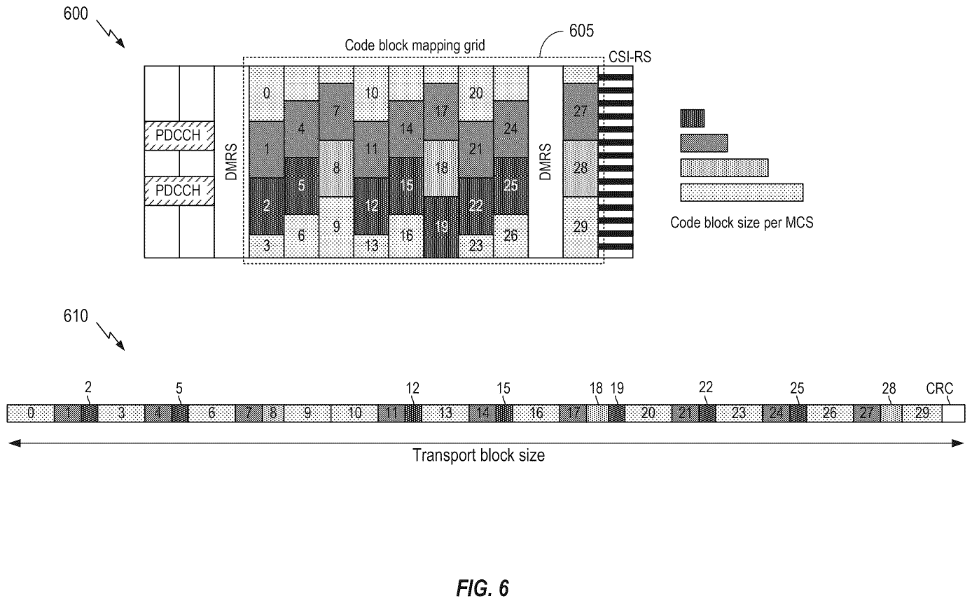

At 508, the wireless communications device 504 calculates a quantity of mapped code blocks C_{ref}. The quantity of mapped code blocks C_{ref} represents a quantity of code blocks that can be mapped to a set of resources allocated for the communication based on a highest MCS (denoted as MCS_{high}) of the set of MCSs configured for the wireless communications device 504. Thus, in some aspects, the wireless communications device 504 may calculate the quantity of mapped code blocks C_{ref} based at least in part on MCS_{high}. That is, the wireless communications device 504 may use the highest MCS (MCS_{high}) from the set of MCSs (e.g., configured as described with respect to operation 506) for calculating the quantity of mapped code blocks C_{ref} (i.e., MCS_{high}=max(MCSᵢ)). Of note, using the highest MCS for calculating the quantity of mapped code blocks C_{ref} determines a mapping grid for all code blocks (regardless of the actual MCS ultimately selected for each mapped code block). For example, with reference to example 600 in FIG. 6, the use of MCS_{high} results in a quantity of 30 mapped code blocks (C_{ref}=30) and determines a mapping grid for all 30 mapped code blocks (regardless of the actual MCS ultimately selected for each of the 30 mapped code blocks).

In some aspects, the wireless communications device 504 may calculate the quantity of mapped code blocks C_{ref} according to the following equation:

$${C}_{ref} = ⌈ \frac{{N}_{{info}_{ref}}^{′} + 24}{8424} ⌉ \qquad ( 1 )$$

where

$${N}_{{info}_{ref}}^{′}$$

represents an integer number of bytes associated with MCS_{high} and is calculated according to the following equation:

$${N}_{{info}_{ref}}^{′} = {2}^{n} \cdot round ( \frac{{N}_{{info}_{ref}} - 24}{{2}^{n}} ) , \\ n = ⌊ {log}_{2} ( {N}_{{info}_{ref}} - 24 ) ⌋ - 5 \qquad ( 2 )$$

where N_{info}_{_{ref}} represents a number of information bits associated with MCS_{high} and is calculated according to the following equation:

N_{info}_{_{ref}}=N_{RE}·B_{ref}·Qₘ_{_{ref}}·v (3)

where N_{RE} represents a total number of resource elements (REs) available for data transfer (e.g., a number of REs in a set of resources allocated for the communication), Qₘ_{_{ref}} represents a modulation order of MCS_{high}, R_{ref} represents a coding rate of MCS_{high}, and v represents a number of layers of the communication (e.g., determined based at least in part on DCI that schedules the communication). The value of 24 in equations (1) and (2) is an example for a cyclic redundancy check (CRC) length and, in practice, a different CRC length value may be used.

At 510, the wireless communications device 504 determines a set of code block sizes based at least in part on the quantity of mapped code blocks C_{ref}. In some aspects, each code block size (denoted as

$${K}_{i}^{′}$$

) in the set of code block sizes is determined based at least in part on a unique (different) MCS from the set of MCSs. That is, in some aspects, the wireless communications device 504 may determine a code block size

$${K}_{i}^{′}$$

for each MCSᵢ, while setting the quantity of code blocks for each code block size calculation to the quantity of mapped code blocks C_{ref} (rather than calculating a different quantity of code blocks for each code block size calculation). In this way, the same code block mapping grid (e.g., a grid of code blocks mapped to a set resources, an example of which is illustrated in FIG. 6) is applied for the for each MCSᵢ.

In some aspects, the wireless communications device 504 may determine a code block size

$${K}_{i}^{′}$$

for a given MCSᵢ according to the following equation:

$${K}_{i}^{′} = \frac{{TBS}_{i} + {C}_{ref} \cdot 24}{{C}_{ref}} \qquad ( 4 )$$

where TBSᵢ represents a transport block size associated with MCSᵢ and is determined according to the following equation:

$${TBS}_{i} = 8 \cdot {C}_{ref} \cdot ⌈ \frac{{N}_{{info}_{i}}^{′} + 24}{8 \cdot {C}_{ref}} ⌉ - 24 \qquad ( 5 )$$

where

$${N}_{{info}_{ref}}^{′}$$

represents an integer number of bytes associated with MCSᵢ and is determined according to the following equation:

$${N}_{{info}_{i}}^{′} = {2}^{n} \cdot round ( \frac{{N}_{{info}_{i}} - 24}{{2}^{n}} ) , n = ⌊ {log}_{2} ( {N}_{{info}_{i}} - 24 ) ⌋ - 5 \qquad ( 6 )$$

where N_{info}_{ᵢ} represents a number of information bits associated with MCSᵢ and is calculated according to the following equation:

N_{info}_{ᵢ}=N_{RE}·Rᵢ·Qₘ_{ᵢ}·v (7)

where Qₘ_{ᵢ} represents a modulation order of MCSᵢ and Rᵢ represents a coding rate of MCSᵢ. The value of 24 in equations (4)-(6) is an example for a CRC length and, in practice, a different CRC length value may be used.

The wireless communications device 504 performs this determination for each MCSᵢ, meaning that the wireless communications device 504 determines a code block size Kᵢ′ for each MCSᵢ in the set of MCSs. As indicated above, each code block size Kᵢ′ is determined based at least in part on the same quantity of mapped code blocks C_{ref} (i.e., the quantity of mapped code blocks C_{ref} that is derived based on MCS_{high}).

At 512, the wireless communications device 504 selects an MCS, from the set of MCSs, for each mapped code block in the quantity of mapped code blocks. For example, each code block in the quantity of mapped code blocks C_{ref} may be associated with a respective code block index r, where r={0 . . . C_{ref}−1}. The wireless communications device 504 may then select an MCSᵣ, from the set of MCSs, for each code block index r. That is, the wireless communications device 504 may select a respective MCSᵢ for each mapped code block in the quantity of mapped code blocks C_{ref}. Here, the MCSs selected by the wireless communications device 504 may vary among the code blocks (e.g., such that different MCSs are selected for different mapped code blocks).

In some aspects, the wireless communications device 504 may select an MCS for a mapped code block based at least in part on an estimated MCS. For example, the wireless communications device 504 may store or have access to a model configured for estimating MCSs based on a set of channel characteristics of a resource (e.g., a subband) associated with the mapped code block. In such aspects, the wireless communications device 504 may determine (e.g., measure) the set of channel characteristics, provide the set of channel characteristics input to the model, and receive an estimated MCS as an output of the model. The wireless communications device 504 may the select an MCS, from the set of MCSs, based at least in part on the estimated MCS (e.g., by selecting an MCS that matches the estimated MCS, by selecting an MCS that is most similar to the estimated MCS, or the like). In this way, the wireless communications device 504 may implement a channel aware technique for code block MCS selection. In some aspects, the wireless communications device 504 may receive an activation indication associated with using the model, and may determine the estimated MCS using the model in accordance with the activation indication. That is, in some aspects, an explicit activation (or de-activation) signaling protocol may be used for activating the channel aware technique for code block MCS selection.

In some aspects, the wireless communications device 504 may select the MCS for the mapped code block based at least in part on the reference MCS and an MCS offset that is associated with a subband that at least partially overlaps in the mapped code block. For example, the wireless communications device 504 may determine a reference MCS (e.g., via DCI, as described with respect to operation 506), denoted as MCS_{DCI}. The wireless communications device 504 may also determine a set of MCS offsets (e.g., via a MAC CE that indicates the set of MCS offsets or based on converting a set of reported subband metrics to MCS offsets in accordance with an RRC configuration, as described with respect to operation 506). Here, each MCS offset in the set of MCS offsets may be associated with a respective subband in a set of subbands. Thus, the wireless communications device 504 may determine MCS offsets per subband sb (denoted as ΔMCS_{sb}). The wireless communications device 504 may then select an MCS for each mapped code block based at least in part on the reference MCS and an MCS offset, from the set of MCS offsets, that is associated with a subband that at least partially overlaps the mapped code block. That is, the wireless communications device 504 may identify a subband that at least partially overlaps the mapped code block and identify an MCS offset (ΔMCS_{sb}) that corresponds to the subband. The wireless communications device 504 may then select the MCS based on a difference between the reference MCS and the MCS offset (e.g., MCSᵢ=MCS_{DCI}−ΔMCS_{sb}, where sb={0 . . . N_{RBG}−1}, and N_{RBG} is a quantity of subbands).

In some aspects, the wireless communications device 504 may select the MCS for the mapped code block based at least in part on a set of rules for selecting MCS offsets when a plurality of subbands at least partially overlap a given mapped code bock. For example, the wireless communications device 504 may receive (e.g., via RRC signaling) or be configured with a set of rules for selecting MCS offsets when a plurality of subbands at least partially overlap a given mapped code bock (e.g., as described with respect to operation 506). The wireless communications device 504 may identify a plurality of subbands that at least partially overlap the mapped code block, and identify MCS offsets (ΔMCS_{sb}) that correspond to the plurality of subbands (e.g., when the mapped code block at least partially overlaps more than one subband). The wireless communications device 504 may then select a particular MCS offset of the plurality of MCS offsets in accordance with the set of rules. For example, the set of rules may indicate that the wireless communications device 504 is to select an MCS offset that results in a lowest MCS to be selected for the mapped code block. In such examples, the wireless communications device 504 may determine a plurality of MCSs, each associated with a respective MCS offset of the plurality of MCS offsets (e.g., based on the reference MCS and each of the plurality of MCS offsets), and may select the MCS offset that results in the lowest MCS (e.g., in accordance with the set of rules).

In some aspects, the wireless communications device 504 may receive an activation indication associated with selecting MCSs based at least in part on the reference MCS and the set of MCS offsets, and may select MCSs for the mapped code blocks in accordance with the activation indication. That is, in some aspects, an explicit activation (or de-activation) signaling protocol may be used for activating MCS selection based at least in part on MCS offsets.

At 514, the wireless communications device 504 identifies a code block size, from the set of code block sizes, for each mapped code block based at least in part on the selected MCSs. For example, the wireless communications device 504 may identify a code block size Ky, from the set of code block sizes that includes the code block sizes Kᵢ′ (e.g., determined as described with respect to operation 510), to be used for each mapped code block in the quantity of mapped code blocks C_{ref}, with the identification of the code block size Kᵣ′ being based on the selected MCSᵣ. That is, the wireless communications device 504 may identify the code block size Kᵢ′, associated with the selected MCSᵣ, as the code block size Kᵣ′ for a given mapped code block in the quantity of mapped code blocks C_{ref}. In this way, the wireless communications device 504 may identify a code block size Kᵣ′ for each mapped code block. Here, because the MCSs may vary among the mapped code blocks as noted above, the code block size may vary among the mapped code blocks.

As an example, with reference to the example 600 in FIG. 6, the wireless communications device 504 identifies a code block size for each of the 30 mapped code blocks (numbered 0-29) in the code block mapping grid 605. As indicated in the example 600, code block size may vary among the mapped code blocks as a result of the variation of MCSs among the mapped code blocks.

Returning to FIG. 5, at 516, the wireless communications device 504 calculates a transport block size associated with the communication based at least in part on the code block sizes selected for the mapped code blocks. For example, the wireless communications device 504 may calculate a transport block size TBS_{actual} according to the following equation:

$${TBS}_{actual} = {\sum }_{r = 0}^{{C}_{ref} - 1} ( {K}_{r}^{′} - 24 ) \qquad ( 8 )$$

In this way, the wireless communications device 504 may calculate a transport block size TBS_{actual} for the communication while providing dynamic MCS per code block (e.g., variation in MCS among code blocks of the transport block).

As an illustrative example, with reference to example 610 in FIG. 6, the actual transport block size (e.g., needed for transport block cyclic redundancy (CRC) calculation) may be calculated by concatenating the code blocks sizes identified for each of the 30 mapped code blocks.

Returning to FIG. 5, at 518, the wireless communications device 504 may communicate (e.g., transmit or receive) the communication in accordance with the transport block size. For example, if the wireless communication is a downlink communication (e.g., a PDSCH communication), then the wireless communications device 504 may transmit the downlink communication in accordance with the transport block size. Alternatively, if the wireless communication is an uplink communication (e.g., a PUSCH communication), then the wireless communications device 504 may receive the uplink communication in accordance with the transport block size.

Note that the process flow illustrated in FIG. 5is an example of implementing dynamic MCS per code block, and aspects of the present disclosure may be applied to dynamic MCS per code block. Note that the process flow illustrated in FIG. 5is described herein to facilitate an understanding of dynamic MCS per code block, and aspects of the present disclosure may be performed in various manners via alternative or additional signaling and/or operations. In certain aspects, the operations and/or signaling of FIG. 5 may occur in an order different from that described or depicted, and various actions, operations, and/or signaling may be added, omitted, or combined.

In some aspects, the dynamic MCS per code block depicted and described with respect to the example 500 may enable improved wireless communications performance, such as increased resource efficiency and increased channel capacity efficiency. The improved wireless communication performance may be attributable to the techniques and apparatuses depicted and described with respect to the example 500 due to, for example, enabling MCS to vary among code blocks of a transport block. Further, the techniques and apparatuses depicted and described with respect to the example 500 may enable legacy transport block calculations to be reused with relatively minor updates, meaning that implementation of the dynamic MCS per code block is relatively simple. Additionally, the techniques and apparatuses depicted and described with respect to the example 500 may enable a probability of error per code block to be the same over a group of code blocks, which can enable efficiency with respect to the provisioning of feedback for a given code block group to be increased (e.g., by enabling code block group feedback to be provided via a single bit).

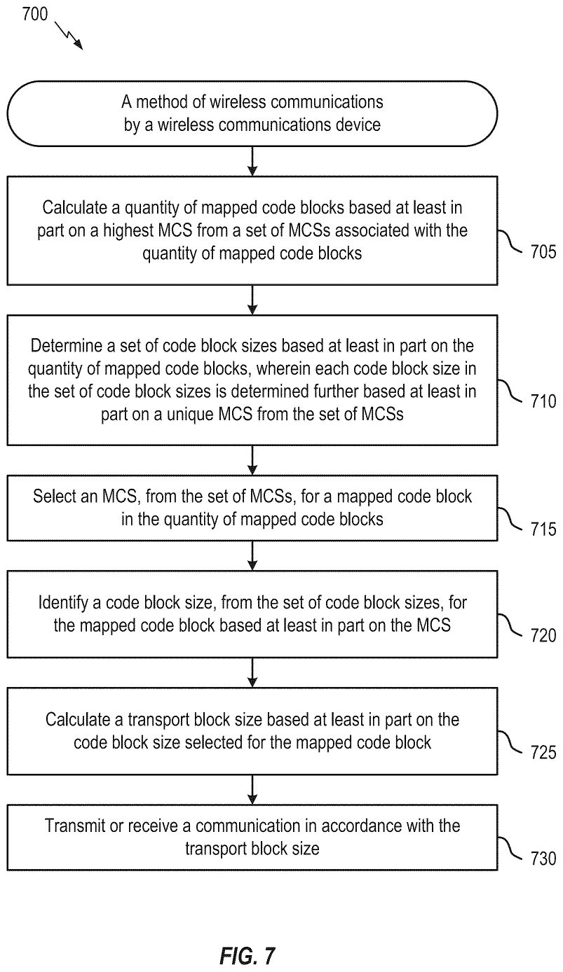

FIG. 7 shows a method 700 for wireless communications by a wireless communications device, such as UE 104 of FIG. 10r UE 304 of FIG. 3

Method 700 begins at block 705 with calculating a quantity of mapped code blocks based at least in part on a highest MCS from a set of MCSs associated with the quantity of mapped code blocks. For example, the wireless communications device 504 may calculate a quantity of mapped code blocks based at least in part on a highest MCS from a set of MCSs associated with the mapped quantity of code blocks, as depicted and described with respect to operation 508 of FIG. 5.

Method 700 then proceeds to block 710 with determining a set of code block sizes based at least in part on the quantity of mapped code blocks, wherein each code block size in the set of code block sizes is determined further based at least in part on a unique MCS from the set of MCSs. For example, the wireless communications device 504 may determine a set of code block sizes based at least in part on the quantity of mapped code blocks, as depicted and described with respect to operation 510 of FIG. 5.

Method 700 then proceeds to block 715 with selecting an MCS, from the set of MCSs, for a mapped code block in the quantity of mapped code blocks. For example, the wireless communications device 504 may select an MCS, from the set of MCSs, for a mapped code block in the quantity of mapped code blocks, as depicted and described with respect to operation 512 of FIG. 5.

Method 700 then proceeds to block 720 with identifying a code block size, from the set of code block sizes, for the mapped code block based at least in part on the MCS. For example, the wireless communications device 504 may identify a code block size, from the set of code block sizes, for the mapped code block based at least in part on the MCS, as depicted and described with respect to operation 514 of FIG. 5

Method 700 then proceeds to block 725 with calculating a transport block size based at least in part on the code block size selected for the mapped code block. For example, the wireless communications device 504 may calculate a transport block size based at least in part on the code block size selected for the mapped code block, as depicted and described with respect to operation 516 of FIG. 5.

Method 700 then proceeds to block 730 with transmitting or receiving a communication in accordance with the transport block size. For example, the wireless communications device 504 may transmit or receive a communication in accordance with the transport block size, as depicted and described with respect to operation 518 of FIG. 5.

In some aspects, method 700 further includes receiving a configuration indicating the set of MCSs.

In some aspects, method 700 further includes determining an estimated MCS using a model configured for estimating MCSs based on a set of channel characteristics, wherein block 715 includes selecting the MCS based at least in part on the estimated MCS.

In some aspects, method 700 further includes receiving an activation indication associated with using the model, wherein the estimated MCS is determined using the model in accordance with the activation indication.

In some aspects, method 700 further includes receiving DCI indicating a reference MCS, and determining a set of MCS offsets, wherein: each MCS offset in the set of MCS offsets is associated with a respective subband in a set of subbands, and block 715 includes selecting the MCS for the mapped code block based at least in part on the reference MCS and an MCS offset, from the set of MCS offsets, that is associated with a subband that at least partially overlaps in the mapped code block.

In some aspects, method 700 further includes receiving a MAC CE indicating a set of MCS offsets, wherein determining the set of MCS offsets comprises determining the set of MCS offsets based at least in part on the MAC CE.

In some aspects, method 700 further includes receiving a RRC configuration associated with converting reported subband metrics to MCS offsets.

In some aspects, method 700 further includes converting a set of reported subband metrics to a set of MCS offsets in accordance with the RRC configuration, wherein determining the set of MCS offsets comprises determining the set of MCS offsets based at least in part on a result of converting the set of reported subband metrics to the set of MCS offsets.

In some aspects, block 715 includes selecting the MCS for the mapped code block based at least in part on a set of rules for selecting MCS offsets when a plurality of subbands at least partially overlap a given mapped code bock.

In some aspects, method 700 further includes receiving the set of rules via RRC signaling.

In some aspects, the set of rules is configured in accordance with a wireless communications standard.

In some aspects, method 700 further includes receiving an activation indication associated with selecting the MCS based at least in part on the reference MCS and the set of MCS offsets, wherein block 715 includes selecting the MCS for the mapped code block based at least in part on the reference MCS and the MCS offset, from the set of MCS offsets, in accordance with the activation indication.

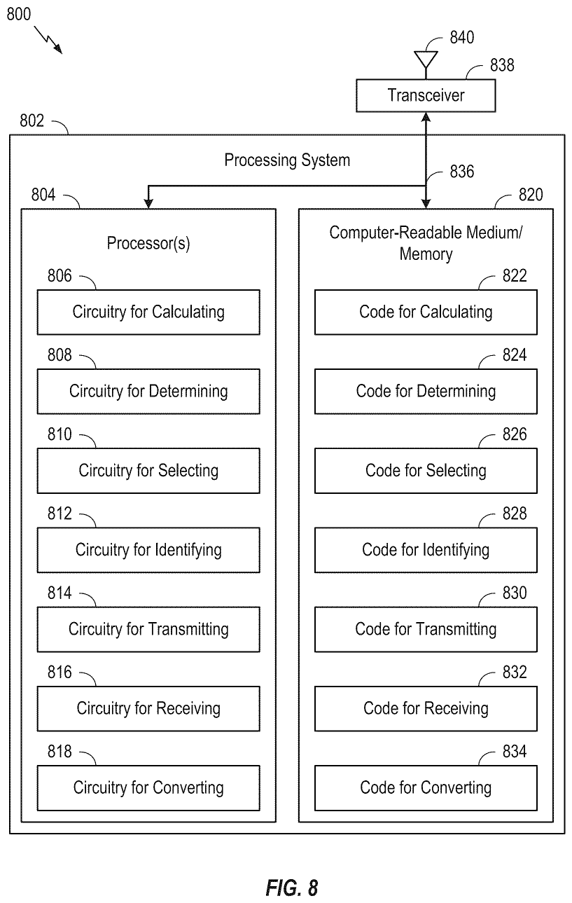

In some aspects, method 700, or any aspect related to it, may be performed by an apparatus, such as communications device 800 of FIG. 8, which includes various components operable, configured, or adapted to perform the method 700. Communications device 800 is described below in further detail.

In some aspects, the dynamic MCS per code block depicted and described with respect to the method 700 may enable improved wireless communications performance, such as increased resource efficiency and increased channel capacity efficiency. The improved wireless communication performance may be attributable to the method 700 due to, for example, enabling MCS to vary among code blocks of a transport block. Further, the method 700 may enable legacy transport block calculations to be reused with relatively minor updates, meaning that implementation of the dynamic MCS per code block is relatively simple. Additionally, the method 700 may enable a probability of error per code block to be the same over a group of code blocks, which can enable efficiency with respect to the provisioning of feedback for a given code block group to be increased (e.g., by enabling code block group feedback to be provided via a single bit).

Note that FIG. 7 is just one example of a method, and other methods including fewer, additional, or alternative operations are possible consistent with this disclosure.

### Example Communications Device

FIG. 8 depicts aspects of an example communications device 800 configured for wireless communications. In some aspects, communications device 800 is a user equipment, such as UE 104 described above with respect to FIG. 1 or UE 304 described with respect to FIG. 3.

The communications device 800 includes a processing system 802 coupled to a transceiver 838 (e.g., a transmitter and/or a receiver). The transceiver 838 is configured to transmit and receive signals for the communications device 800 via an antenna 840, such as the various signals as described herein. The processing system 802 may be configured to perform processing functions for the communications device 800, including processing signals received and/or to be transmitted by the communications device 800.

The processing system 802 includes one or more processors 804 and a computer-readable medium/memory 820. In various aspects, the one or more processors 804 may be representative of the one or more processors 318 described with respect to FIG. 3. The one or more processors 804 are coupled to a computer-readable medium/memory 820 via a bus 836. In some aspects, the computer-readable medium/memory 820 may be representative of the one or more memories 320 described with respect to FIG. 3. The computer-readable medium/memory 820 is a non-transitory computer-readable medium/memory. In certain aspects, the computer-readable medium/memory 820 is configured to store instructions (e.g., computer-executable code), that when executed by the one or more processors 804, cause the one or more processors 804 to perform the method 700 described with respect to FIG. 7, or any aspect related to it, including any operations described in relation to FIG. 7. Note that reference to a processor performing a function of communications device 800 may include one or more processors performing that function of communications device 800, such as in a distributed fashion.

In the depicted example, computer-readable medium/memory 820 stores code (e.g., executable instructions), including code for calculating 822, code for determining 824, code for selecting 826, code for identifying 828, code for transmitting 830, code for receiving 832, and code for converting 834. Processing of the code 822-834 may enable and cause the communications device 800 to perform the method 700 described with respect to FIG. 7, or any aspect related to it. For instance, in some aspects, code for calculating 822 includes code for calculating a quantity of mapped code blocks based at least in part on a highest MCS from a set of MCSs associated with the quantity of mapped code blocks. In some aspects, code for determining 824 includes code for determining a set of code block sizes based at least in part on the quantity of mapped code blocks, wherein each code block size in the set of code block sizes is determined further based at least in part on a unique MCS from the set of MCSs. In some aspects, code for selecting 826 includes code for selecting an MCS, from the set of MCSs, for a mapped code block in the quantity of mapped code blocks. In some aspects, code for identifying 828 includes code for identifying a code block size, from the set of code block sizes, for the mapped code block based at least in part on the MCS. In some aspects, code for calculating 822 includes code for calculating a transport block size based at least in part on the code block size selected for the mapped code block. In some aspects, code for transmitting 830 includes code for transmitting a communication in accordance with the transport block size. In some aspects, code for receiving 832 includes code for receiving a communication in accordance with the transport block size.

The one or more processors 804 include circuitry configured to implement (e.g., execute) the code stored in the computer-readable medium/memory 820, including circuitry for calculating 806, circuitry for determining 808, circuitry for selecting 810, circuitry for identifying 812, circuitry for transmitting 814, circuitry for receiving 816, and circuitry for converting 818. Processing with circuitry 806-818 may enable and cause the communications device 800 to perform the method 700 described with respect to FIG. 7, or any aspect related to it. For instance, in some aspects, circuitry for calculating 806 includes circuitry for calculating a quantity of mapped code blocks based at least in part on a highest MCS from a set of MCSs associated with the quantity of mapped code blocks. In some aspects, circuitry for determining 808 includes circuitry for determining a set of code block sizes based at least in part on the quantity of mapped code blocks, wherein each code block size in the set of code block sizes is determined further based at least in part on a unique MCS from the set of MCSs. In some aspects, circuitry for selecting 810 includes circuitry for selecting an MCS, from the set of MCSs, for a mapped code block in the quantity of mapped code blocks. In some aspects, circuitry for identifying 812 includes circuitry for identifying a code block size, from the set of code block sizes, for the mapped code block based at least in part on the MCS. In some aspects, circuitry for calculating 806 includes circuitry for calculating a transport block size based at least in part on the code block size selected for the mapped code block. In some aspects, circuitry for transmitting includes circuitry for transmitting a communication in accordance with the transport block size. In some aspects, circuitry for receiving 816 includes circuitry for receiving a communication in accordance with the transport block size.

More generally, means for communicating, transmitting, sending or outputting for transmission may include the one or more transceivers 324, one or more antenna 322 and/or processing system 316 of the UE 304 illustrated in FIG. 3, transceiver 838 and/or antenna 840 of the communications device 800 in FIG. 8, and/or one or more processors 804 of the communications device 800 in FIG. 8 means for communicating, receiving or obtaining may include the one or more transceivers 324, one or more antennas 322, and/or processing system 316 of the UE 304 illustrated in FIG. 3, transceiver 838 and/or antenna 840 of the communications device 800 in FIG. 8, and/or one or more processors 804 of the communications device 800 in FIG. 8

### EXAMPLE CLAUSES

Implementation examples are described in the following numbered clauses:
Clause 1: A method of wireless communications by a wireless communications device, comprising: calculating a quantity of mapped code blocks based at least in part on a highest MCS from a set of MCSs associated with the quantity of mapped code blocks; determining a set of code block sizes based at least in part on the quantity of mapped code blocks, wherein each code block size in the set of code block sizes is determined further based at least in part on a unique MCS from the set of MCSS; selecting an MCS, from the set of MCSs, for a mapped code block in the quantity of mapped code blocks; identifying a code block size, from the set of code block sizes, for the mapped code block based at least in part on the MCS; calculating a transport block size based at least in part on the code block size selected for the mapped code block; and transmitting or receiving a communication in accordance with the transport block size.
Clause 2: The method of Clause 1, further comprising receiving a configuration indicating the set of MCSs.
Clause 3: The method of any one of Clauses 1-2, further comprising: determining an estimated MCS using a model configured for estimating MCSs based on a set of channel characteristics, wherein selecting the MCS from the mapped code block comprises selecting the MCS based at least in part on the estimated MCS.
Clause 4: The method of Clause 3, further comprising: receiving an activation indication associated with using the model, wherein the estimated MCS is determined using the model in accordance with the activation indication.
Clause 5: The method of any one of Clauses 1-4, further comprising: receiving DCI indicating a reference MCS, and determining a set of MCS offsets, wherein: each MCS offset in the set of MCS offsets is associated with a respective subband in a set of subbands, and selecting the MCS for the mapped code block comprises selecting the MCS for the mapped code block based at least in part on the reference MCS and an MCS offset, from the set of MCS offsets, that is associated with a subband that at least partially overlaps in the mapped code block.
Clause 6: The method of Clause 5, further comprising: receiving a MAC CE indicating a set of MCS offsets, wherein determining the set of MCS offsets comprises determining the set of MCS offsets based at least in part on the MAC CE.
Clause 7: The method of Clause 5, further comprising: receiving a RRC configuration associated with converting reported subband metrics to MCS offsets; and converting a set of reported subband metrics to a set of MCS offsets in accordance with the RRC configuration, wherein determining the set of MCS offsets comprises determining the set of MCS offsets based at least in part on a result of converting the set of reported subband metrics to the set of MCS offsets.
Clause 8: The method of Clause 5, wherein selecting the MCS for the mapped code block comprises selecting the MCS for the mapped code block based at least in part on a set of rules for selecting MCS offsets when a plurality of subbands at least partially overlap a given mapped code bock.
Clause 9: The method of Clause 8, further comprising receiving the set of rules via RRC signaling.
Clause 10: The method of Clause 8, wherein the set of rules is configured in accordance with a wireless communications standard.
Clause 11: The method of Clause 5, further comprising: receiving an activation indication associated with selecting the MCS based at least in part on the reference MCS and the set of MCS offsets, wherein selecting the MCS for the mapped code block comprises selecting the MCS for the mapped code block based at least in part on the reference MCS and the MCS offset, from the set of MCS offsets, in accordance with the activation indication.
Clause 12: One or more apparatuses, comprising: one or more memories comprising executable instructions; and one or more processors configured to execute the executable instructions and cause the one or more apparatuses to perform a method in accordance with any one of Clauses 1-11.
Clause 13: One or more apparatuses configured for wireless communications, comprising: one or more memories; and one or more processors, coupled to the one or more memories, configured to cause the one or more apparatuses to perform a method in accordance with any one of Clauses 1-11.
Clause 14: One or more apparatuses configured for wireless communications, comprising: one or more memories; and one or more processors, coupled to the one or more memories, configured to perform a method in accordance with any one of Clauses 1-11.
Clause 15: One or more apparatuses, comprising means for performing a method in accordance with any one of Clauses 1-11.
Clause 16: One or more non-transitory computer-readable media comprising executable instructions that, when executed by one or more processors of one or more apparatuses, cause the one or more apparatuses to perform a method in accordance with any one of Clauses 1-11.
Clause 17: One or more computer program products embodied on one or more computer-readable storage media comprising code for performing a method in accordance with any one of Clauses 1-11.
Clause 18: One or more apparatuses configured for wireless communications, comprising: a processing system that includes one or more processors and one or more memories coupled with the one or more processors, the processing system configured to cause the one or more apparatuses to perform a method in accordance with any one of Clauses 1-11.

### ADDITIONAL CONSIDERATIONS

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a SoC, a SiP, or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an A SIC, or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “the processor,” etc.), unless otherwise specifically stated, should be understood to refer to one or more elements (e.g., “one or more processors,” or the like). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus for wireless communications, comprising a processing system that includes one or more processors and one or more memories coupled with the one or more processors, the processing system configured to cause a wireless communications device to:
calculate a quantity of mapped code blocks based at least in part on a highest modulation and coding scheme (MCS) from a set of MCSs associated with the quantity of mapped code blocks;
determine a set of code block sizes based at least in part on the quantity of mapped code blocks, wherein each code block size in the set of code block sizes is determined further based at least in part on a unique MCS from the set of MCSS;
select an MCS, from the set of MCSs, for a mapped code block in the quantity of mapped code blocks;
identify a code block size, from the set of code block sizes, for the mapped code block based at least in part on the MCS;
calculate a transport block size based at least in part on the code block size selected for the mapped code block; and
transmit or receive a communication in accordance with the transport block size.

2. The apparatus of claim 1, wherein the processing system is configured to further cause the wireless communications device to receive a configuration indicating the set of MCSs.

3. The apparatus of claim 1, wherein the processing system is configured to further cause the wireless communications device to:
determine an estimated MCS using a model configured for estimating MCSs based on a set of channel characteristics,
wherein selecting the MCS from the mapped code block comprises selecting the MCS based at least in part on the estimated MCS.

4. The apparatus of claim 3, wherein the processing system is configured to further cause the wireless communications device to:
receive an activation indication associated with using the model,
wherein the estimated MCS is determined using the model in accordance with the activation indication.

5. The apparatus of claim 1, wherein the processing system is configured to further cause the wireless communications device to:
receive downlink control information (DCI) indicating a reference MCS, and
determine a set of MCS offsets,
wherein:
each MCS offset in the set of MCS offsets is associated with a respective subband in a set of subbands, and
to cause the wireless communications device to select the MCS for the mapped code block, the processing system is configured to cause the wireless communications device to select the MCS for the mapped code block based at least in part on the reference MCS and an MCS offset, from the set of MCS offsets, that is associated with a subband that at least partially overlaps in the mapped code block.

6. The apparatus of claim 5, wherein the processing system is configured to further cause the wireless communications device to:
receive a medium access control (MAC) control element (CE) indicating a set of MCS offsets,
wherein to cause the wireless communications device to determine the set of MCS offsets, the processing system is configured to cause the wireless communications device to determine the set of MCS offsets based at least in part on the MAC CE.

7. The apparatus of claim 5, wherein the processing system is configured to further cause the wireless communications device to:
receive a radio resource control (RRC) configuration associated with converting reported subband metrics to MCS offsets; and
convert a set of reported subband metrics to a set of MCS offsets in accordance with the RRC configuration,
wherein to cause the wireless communications device to determine the set of MCS offsets, the processing system is configured to cause the wireless communications device to determine the set of MCS offsets based at least in part on a result of converting the set of reported subband metrics to the set of MCS offsets.

8. The apparatus of claim 5, wherein to cause the wireless communications device to select the MCS for the mapped code block, the processing system is configured to cause the wireless communications device to select the MCS for the mapped code block based at least in part on a set of rules for selecting MCS offsets when a plurality of subbands at least partially overlap a given mapped code bock.

9. The apparatus of claim 8, wherein the processing system is configured to further cause the wireless communications device to receive the set of rules via radio resource control (RRC) signaling.

10. The apparatus of claim 8, wherein the set of rules is configured in accordance with a wireless communications standard.

11. The apparatus of claim 5, wherein the processing system is configured to further cause the wireless communications device to:
receive an activation indication associated with selecting the MCS based at least in part on the reference MCS and the set of MCS offsets,
wherein selecting the MCS for the mapped code block comprises selecting the MCS for the mapped code block based at least in part on the reference MCS and the MCS offset, from the set of MCS offsets, in accordance with the activation indication.

12. A method of wireless communications by a wireless communications device, comprising:
calculating a quantity of mapped code blocks based at least in part on a highest modulation and coding scheme (MCS) from a set of MCSs associated with the quantity of mapped code blocks;
determining a set of code block sizes based at least in part on the quantity of mapped code blocks, wherein each code block size in the set of code block sizes is determined further based at least in part on a unique MCS from the set of MCSs;
selecting an MCS, from the set of MCSs, for a mapped code block in the quantity of mapped code blocks;
identifying a code block size, from the set of code block sizes, for the mapped code block based at least in part on the MCS;
calculating a transport block size based at least in part on the code block size selected for the mapped code block; and
transmitting or receiving a communication in accordance with the transport block size.

13. The method of claim 12, further comprising receiving a configuration indicating the set of MCSs.

14. The method of claim 12, further comprising:
determining an estimated MCS using a model configured for estimating MCSs based on a set of channel characteristics,
wherein selecting the MCS from the mapped code block comprises selecting the MCS based at least in part on the estimated MCS.

15. The method of claim 14, further comprising:
receiving an activation indication associated with using the model,
wherein the estimated MCS is determined using the model in accordance with the activation indication.

16. The method of claim 12, further comprising:
receiving downlink control information (DCI) indicating a reference MCS, and
determining a set of MCS offsets,
wherein:
each MCS offset in the set of MCS offsets is associated with a respective subband in a set of subbands, and
selecting the MCS for the mapped code block comprises selecting the MCS for the mapped code block based at least in part on the reference MCS and an MCS offset, from the set of MCS offsets, that is associated with a subband that at least partially overlaps in the mapped code block.

17. The method of claim 16, further comprising:
receiving a medium access control (M A C) control element (CE) indicating a set of MCS offsets,
wherein determining the set of MCS offsets comprises determining the set of MCS offsets based at least in part on the MAC CE.

18. The method of claim 16, further comprising:
receiving a radio resource control (RRC) configuration associated with converting reported subband metrics to MCS offsets; and
converting a set of reported subband metrics to a set of MCS offsets in accordance with the RRC configuration,
wherein determining the set of MCS offsets comprises determining the set of MCS offsets based at least in part on a result of converting the set of reported subband metrics to the set of MCS offsets.

19. The method of claim 16, wherein selecting the MCS for the mapped code block comprises selecting the MCS for the mapped code block based at least in part on a set of rules for selecting MCS offsets when a plurality of subbands at least partially overlap a given mapped code bock.

20. An apparatus of wireless communications, comprising:
means for calculating a quantity of mapped code blocks based at least in part on a highest modulation and coding scheme (MCS) from a set of MCSs associated with the quantity of mapped code blocks;
means for determining a set of code block sizes based at least in part on the quantity of mapped code blocks, wherein each code block size in the set of code block sizes is determined further based at least in part on a unique MCS from the set of MCSs;
means for selecting an MCS, from the set of MCSs, for a mapped code block in the quantity of mapped code blocks;
means for identifying a code block size, from the set of code block sizes, for the mapped code block based at least in part on the MCS;
means for calculating a transport block size based at least in part on the code block size selected for the mapped code block; and
means for transmitting or means for receiving a communication in accordance with the transport block size.
